(19) United States
(12) Patent Application Publication
(10) Pub. No.: US 2009/0081513 A1
(43) Pub. Date: Mar. 26, 2009

(54) GAS DIFFUSION LAYER, FUEL CELL, METHOD FOR MANUFACTURING GAS DIFFUSION LAYER, AND METHOD FOR MANUFACTURING FUEL CELL

(75) Inventors: Yuji SASAKI, Kanagawa-ken (JP); Takahiro TERADA, Kanagawa-ken (JP); Yasutada NAKAGAWA, Kanagawa-ken (JP); Yuichi YOSHIDA, Ibaraki-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/210,459

(22) Filed: Sep. 15, 2008

(30) Foreign Application Priority Data
Sep. 26, 2007 (JP) 2007-248984

(51) Int. Cl. H01M 8/10; H01M 4/02; B05D 5/12

(52) U.S. Cl. 429/30; 429/12; 427/115

(57) ABSTRACT

A gas diffusion layer to be provided on an air electrode of a fuel cell, the gas diffusion layer includes: a portion to be at a relatively high temperature; and a portion to be at a relatively low temperature. Gas permeability of the portion to be at a relatively high temperature is different from gas permeability of the portion to be at a relatively low temperature.

### CROSS-REFERENCE TO RELATED APPLICATIONS

This application is based upon and claims the benefit of priority from the prior Japanese Patent Application No.2007-248984, filed on Sep. 26, 2007; the entire contents of which are incorporated herein by reference.

### BACKGROUND OF THE INVENTION

1. Field of the Invention

This invention relates to a gas diffusion layer, a fuel cell, a method for manufacturing a gas diffusion layer, and a method for manufacturing a fuel cell.

2. Background Art

With the recent progress of electronics, electronic devices have become smaller, more powerful, and more portable, and cells used therein increasingly need downsizing and higher energy density. In this context, fuel cells, which have high capacity although small and lightweight, are attracting attention. In particular, as compared with fuel cells based on hydrogen gas, the direct methanol fuel cell (DMFC) using methanol as its fuel is free from difficulty in handling hydrogen gas and needs no systems for reforming an organic fuel to produce hydrogen. Thus, DMFC is suitable for downsizing.

Such a direct methanol fuel cell has a fuel electrode (anode), a polymer solid electrolyte membrane, and an air electrode (cathode) provided in this order adjacent to each other to form a membrane electrode assembly. A fuel (methanol) is supplied to the fuel electrode side and reacted in a catalyst layer near the polymer solid electrolyte membrane to produce protons (H⁺) and electrons (e⁻).

At the air electrode (cathode) and the fuel electrode (anode), a gas diffusion layer is provided on the surface of the catalyst layer. Of these gas diffusion layers, the gas diffusion layer provided on the air electrode (cathode) side serves to uniformly supply oxygen to the catalyst layer on the air electrode (cathode) side, and also serves to adjust the degree of permeation of water produced in the catalyst layer on the air electrode (cathode) side.

Here, the water produced in the catalyst layer on the air electrode (cathode) side permeates the gas diffusion layer on the air electrode (cathode) side and reaches vapor-liquid equilibrium inside the gas diffusion layer, where water in liquid form and steam in vapor form come to exist. If water contained in the gas diffusion layer on the air electrode (cathode) side becomes excessive, pores in the gas diffusion layer on the air electrode (cathode) side are occluded, causing the problem of impairing permeation of gas (oxygen).

Furthermore, the gas diffusion layer also needs to have suitable moisture retention, because proton conductivity cannot be increased unless the polymer solid electrolyte membrane is moistened.

Thus, a gas diffusion layer having drainability and moisture retention is proposed (see JP-A 2006-324104(kokai) (Patent Document 1) and JP-A 2001-057215(Kokai) (Patent Document 2)).

However, the techniques disclosed in Patent Documents 1 and 2 do not consider the in-plane temperature distribution and the in-plane water (liquid water) distribution in the gas diffusion layer on the air electrode (cathode) side, and may fail to provide suitable drainage and moisture retention.

### SUMMARY OF THE INVENTION

According to an aspect of the invention, there is provided a gas diffusion layer to be provided on an air electrode of a fuel cell, the gas diffusion layer including: a portion to be at a relatively high temperature; and a portion to be at a relatively low temperature, gas permeability of the portion to be at a relatively high temperature being different from gas permeability of the portion to be at a relatively low temperature.

According to an aspect of the invention, there is provided a gas diffusion layer to be provided on an air electrode of a fuel cell, the gas diffusion layer including: a portion to contain a relatively large amount of water; and a portion to contain a relatively small amount of water, gas permeability of the portion to contain a relatively large amount of water being different from gas permeability of the portion to contain a relatively small amount of water.

According to an aspect of the invention, there is provided a fuel cell including: a fuel electrode to be supplied with a fuel; an air electrode to be supplied with an oxidizer; and a polymer solid electrolyte membrane sandwiched between the fuel electrode and the air electrode, the air electrode having a gas diffusion layer to be provided on an air electrode of a fuel cell, the gas diffusion layer including: a portion to be at a relatively high temperature; and a portion to be at a relatively low temperature, gas permeability of the portion to be at a relatively high temperature being different from gas permeability of the portion to be at a relatively low temperature.

According to an aspect of the invention, there is provided a method for manufacturing a gas diffusion layer to be provided on an air electrode of a fuel cell, the gas diffusion layer including a first portion to be at a relatively high temperature and a second portion to be at a relatively low temperature during operation of the fuel cell, the method including: applying mixed solutions dispersed with carbon black having different particle diameters to the first portion and the second portion; and drying the mixed solutions.

According to an aspect of the invention, there is provided a method for manufacturing a gas diffusion layer to be provided on an air electrode of a fuel cell, the gas diffusion layer including a first portion to contain a relatively large amount of water and a second portion to contain a relatively small amount of water during operation of the fuel cell, the method including: applying mixed solutions dispersed with carbon black having different particle diameters to the first portion and the second portion; and drying the mixed solutions.

According to an aspect of the invention, there is provided a method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method including: manufacturing a gas diffusion layer to be provided on the air electrode by a method for manufacturing a gas diffusion layer to be provided on an air electrode of a fuel cell, the gas diffusion layer including a first portion to be at a relatively high temperature and a second portion to be at a relatively low temperature during operation of the fuel cell, the method including: applying mixed solutions dispersed with carbon black having different particle diameters to the first portion and the second portion; and drying the mixed solutions.

### BRIEF DESCRIPTION OF THE DRAWINGS

FIGS. 1A and 1B are schematic views for illustrating a gas diffusion layer according to an embodiment of the invention;

FIG. 2 is a schematic view for illustrating a variation in the in-plane temperature of the gas diffusion layer;

FIGS. 3A and 3B are schematic views for illustrating the effect of variation in the in-plane temperature of the gas diffusion layer;

FIGS. 4A and 4B are schematic views for illustrating the size of pores provided in the gas diffusion layer;

FIG. 5 is a schematic cross-sectional view for illustrating the gas permeability;

FIG. 6 is a schematic graph for illustrating the function of the gas diffusion layer;

FIG. 7 is a schematic view for illustrating a fuel cell according to the embodiment of the invention;

FIG. 8 is a flow chart for illustrating a method for manufacturing a gas diffusion layer according to the embodiment of the invention; and

FIG. 9 is a flow chart for illustrating a method for manufacturing a fuel cell according to the embodiment of the invention.

### DETAILED DESCRIPTION OF THE INVENTION

An embodiment of the invention will now be illustrated with reference to the drawings.

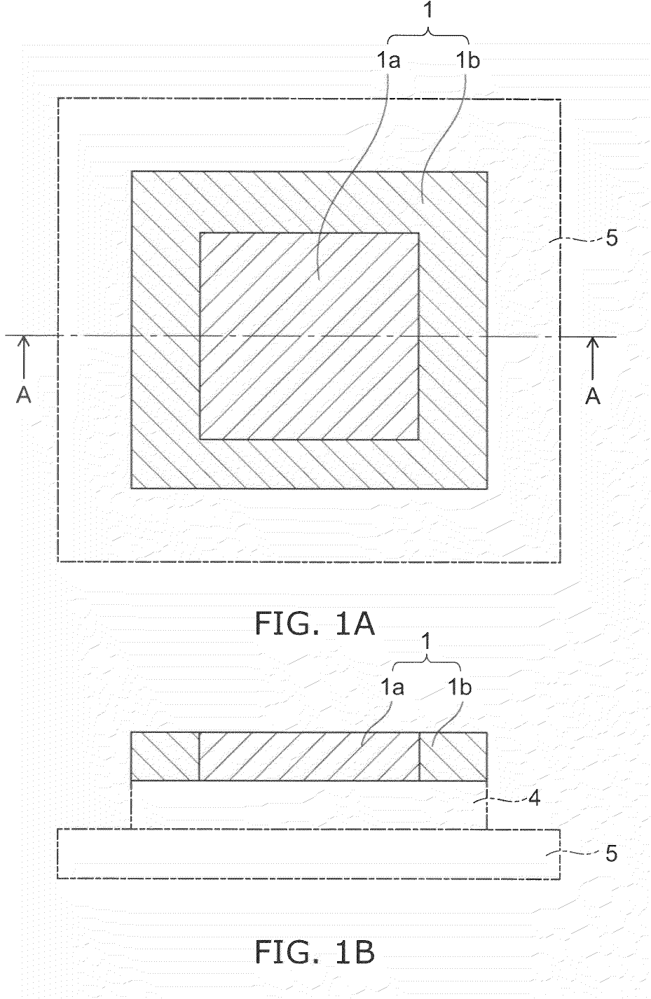

FIGS. 1A and 1B are schematic views for illustrating a gas diffusion layer according to the embodiment of the invention. Here, FIG. 1A is a schematic plan view of the gas diffusion layer, and FIG. 1B is a cross-sectional view as viewed from the direction of arrow A-A in FIG. 1A.

As shown in FIG. 1, the gas diffusion layer 1 includes a first region 1a and a second region 1b, which are different in gas permeability. The gas diffusion layer 1 is provided on the surface of a catalyst layer 4 on the air electrode (cathode) side, described later, and the catalyst layer 4 is provided on the surface of a polymer solid electrolyte membrane 5.

First, a description is given of the drainability and moisture retention of the gas diffusion layer 1.

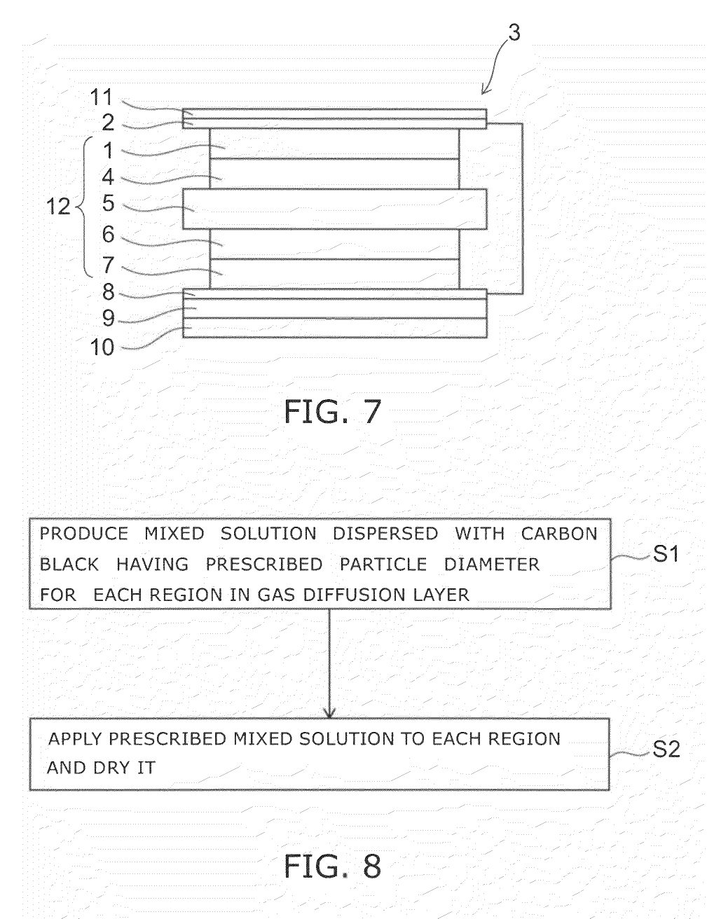

As described later, in a direct methanol fuel cell 3 (see FIG. 7), which is a kind of fuel cell, a fuel (methanol) is supplied to the fuel electrode side and reacted in a catalyst layer 6 near the polymer solid electrolyte membrane 5 to produce protons (H⁺) and electrons (e⁻). At this time, water (H₂O) is produced in the catalyst layer 4 of the air electrode (cathode).

The produced water (H₂O) permeates the gas diffusion layer 1 of the air electrode (cathode) and reaches vapor-liquid equilibrium inside the gas diffusion layer 1. At this time, the reached vapor-liquid equilibrium allows water in liquid form and steam in vapor form to exist in the gas diffusion layer 1.

To allow oxygen taken in from ambient air to diffuse in the gas diffusion layer 1 and reach the catalyst layer 4, the gas diffusion layer 1 is provided with pores serving as permeation paths of gas (oxygen).

If water (liquid water) contained inside the gas diffusion layer 1 becomes excessive, the pores serving as permeation paths of gas (oxygen) are occluded, and permeation of gas (oxygen) is impaired. The impaired permeation of gas (oxygen) prevents the electrochemical reaction described later and decreases the performance of the fuel cell.

Thus, the gas diffusion layer 1 requires drainability to drain (evaporate) excessive water.

On the other hand, unless the polymer solid electrolyte membrane 5 is suitably moistened, proton (H⁺) conductivity, described later, is deteriorated and decreases the performance of the fuel cell. Thus, the gas diffusion layer 1 requires moisture retention to suitably moisten the polymer solid electrolyte membrane 5.

Here, the temperature of the gas diffusion layer 1 is increased by the heat generated by the electrochemical reaction in the catalyst layer 4. However, a variation (unevenness) occurs in the in-plane temperature distribution due to difference in the amount of heat dissipation and the like.

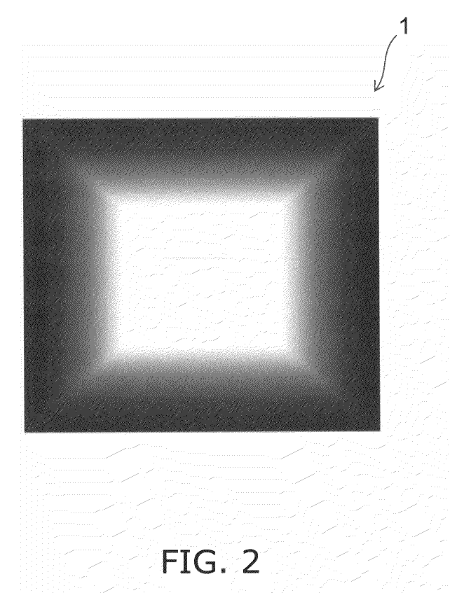

FIG. 2 is a schematic view for illustrating a variation in the in-plane temperature of the gas diffusion layer.

In FIG. 2, a darker shade indicates a lower temperature.

As shown in FIG. 2, in the outer peripheral portion of the gas diffusion layer 1, the temperature decreases because of a larger amount of heat dissipation to the outside. On the other hand, in the central portion, the temperature is less likely to decrease because of a smaller amount of heat dissipation to the outside. This produces a variation in the in-plane temperature in which the temperature is high in the central portion of the gas diffusion layer 1 and becomes lower toward the outer peripheral portion.

Such a variation in the in-plane temperature makes a difference in the vapor-liquid equilibrium inside the gas diffusion layer 1. More specifically, in the high temperature portion, the amount of steam in vapor form is larger than the amount of water in liquid form. However, in the low temperature portion, the amount of water in liquid form is larger than the amount of steam in vapor form.

Hence, in the high-temperature central portion, the amount of water in liquid form is small, and there is a low possibility that pores in the gas diffusion layer 1 are occluded. However, in the low-temperature outer peripheral portion, the amount of water in liquid form is large, and there is a high possibility that pores in the gas diffusion layer 1 are occluded.

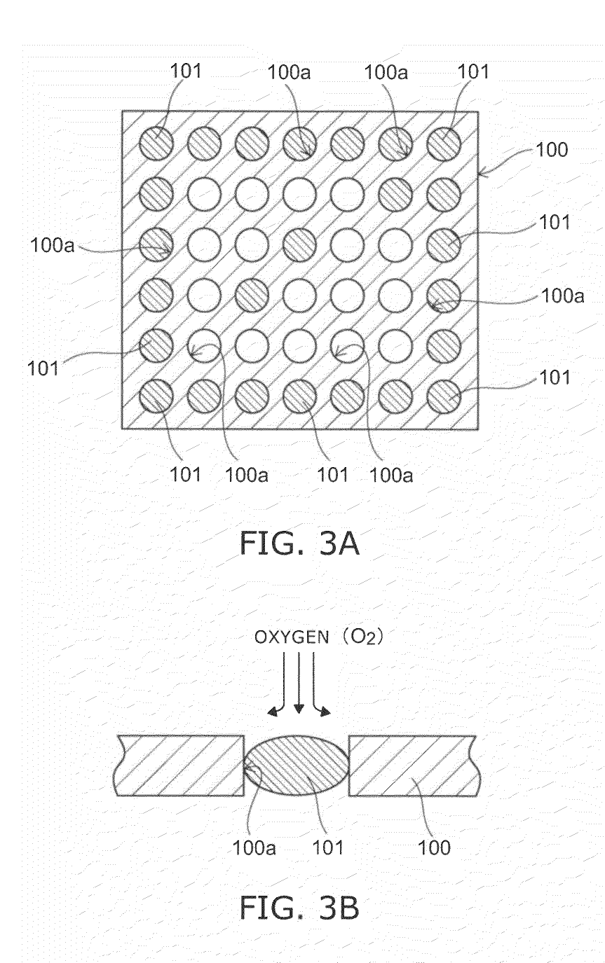

FIGS. 3A and 3 B are schematic views for illustrating the effect of variation in the in-plane temperature of the gas diffusion layer. Here, FIG. 3A is a schematic plan view, and FIG. 3B is a schematic enlarged cross-sectional view of a pore portion.

As shown in FIGS. 3A and 3B, pores 100 a having an equal diameter are uniformly provided in the plane of the gas diffusion layer 100. As shown in FIG. 3A, in the high-temperature central portion, the amount of water in liquid form is small, decreasing the proportion of pores 100a in the gas diffusion layer 100 occluded with water 101. However, in the low-temperature outer peripheral portion, the amount of water in liquid form is large, increasing the proportion of pores 100a in the gas diffusion layer 100 occluded with water 101. As shown in FIG. 3B, if the pore 100a in the gas diffusion layer 100 is occluded with water 101, permeation of oxygen is impaired, and the electrochemical reaction is interrupted. This results in decreased performance of the fuel cell, such as decreased amount of power generation.

In this case, if the diameter of the pores 100a is uniformly increased to enhance drainability, the amount of water retained in the gas diffusion layer 100 decreases, which may deteriorate the moisture retention described above.

In the techniques disclosed in Patent Documents 1 and 2, pores satisfying both drainability and moisture retention or pores having good drainability are uniformly provided in the plane of the gas diffusion layer. However, there is a variation in the in-plane temperature of the gas diffusion layer, and an uneven distribution of water (liquid water) due to this variation. Thus, even if pores having a given size or given shape are uniformly provided in the plane of the gas diffusion layer, the requirements can be met only in part of the plane, and hence there is a possibility that the desired effect cannot be achieved.

As a result of study, the inventor has found that a gas diffusion layer 1 having optimal drainability and moisture retention can be obtained by selecting gas permeability on the basis of the in-plane temperature distribution or the in-plane water distribution in the gas diffusion layer 1.

Here, the gas permeability can be selected by varying the size of pores (e.g., size of the diameter) provided in the gas diffusion layer 1 and/or the dimension of material particles constituting the gas diffusion layer 1. For example, the gas permeability can be increased by increasing the size of pores (e.g., size of the diameter) or increasing the dimension of material particles (particle diameter) to increase the dimension of the gap formed between the particles. Conversely, the gas permeability can be decreased by decreasing them.

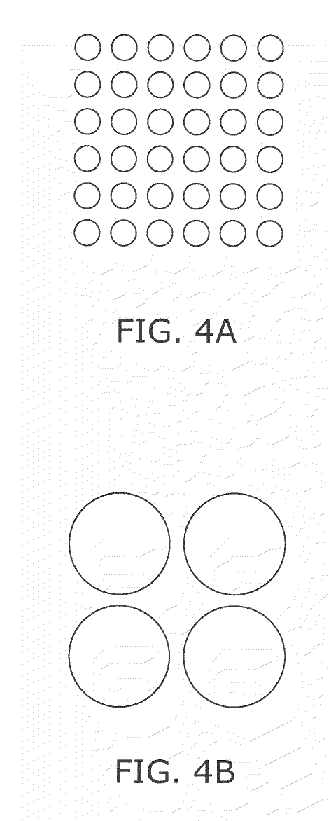

FIGS. 4A and 4B are schematic views for illustrating the size of pores provided in the gas diffusion layer 1.

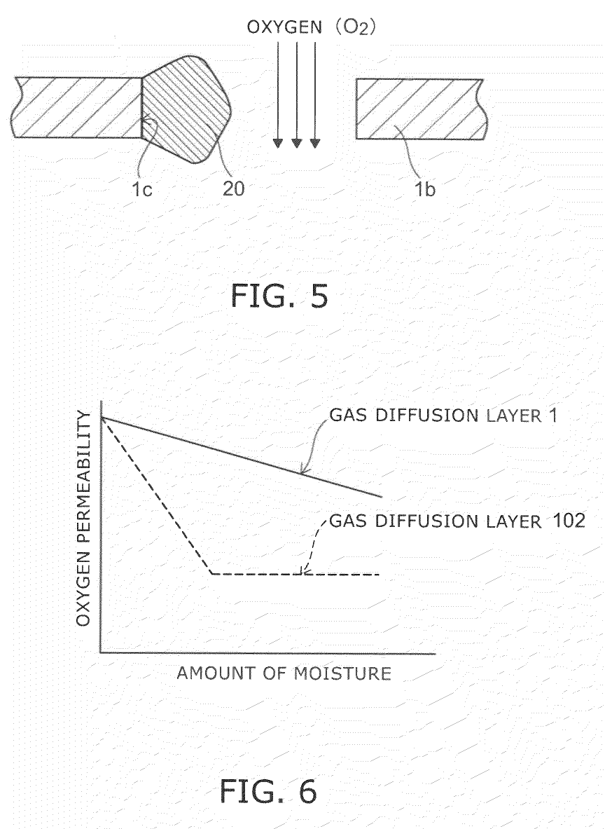

FIG. 5 is a schematic cross-sectional view for illustrating the gas permeability.

As described above, in the high-temperature central portion of the gas diffusion layer 1, the amount of water is small, and there is a low possibility that pores are occluded even if the pore diameter is decreased. On the other hand, in the low-temperature outer peripheral portion of the gas diffusion layer 1 with a large amount of water, occlusion of pores with water can be prevented by increasing the pore diameter.

For example, the first region la illustrated in FIGS. 1A and 1B can be provided with pores having a small diameter illustrated in FIG. 4A. The second region lb can be provided with pores having a large diameter illustrated in FIG. 4B.

If the diameter of a pore is small, the pore can be completely occluded with water by the surface tension of water (see FIG. 3B). However, as shown in FIG. 5, if the diameter of a pore is increased, the pore is not completely occluded with water, although water 20 may attach to the peripheral surface 1c of the pore by surface tension. Hence, permeability of gas (oxygen) can be ensured even in the low-temperature region with a large amount of water.

For convenience of description, the case of selecting the gas permeability by varying the diameter of pores is described herein. However, for example, it is also possible to select the gas permeability by varying the particle diameter of the material constituting the gas diffusion layer 1. Furthermore, the cross-sectional shape of the pore is not limited to a circle shown in the figure, but can be suitably modified.

The inventor has found that the diameter of the pore provided in the high-temperature portion of the gas diffusion layer 1 (e.g., the portion to be at approximately 50° C.) is preferably 5 nm or more and less than 200 nm. A pore diameter of 200 nm or more may be too large to provide suitable moisture retention to the gas diffusion layer 1. On the other hand, a pore diameter of less than 5 nm may be too small to provide suitable drainability to the gas diffusion layer 1, and there is a high possibility that the pore is occluded with water.

The diameter of the pore provided in the low-temperature portion of the gas diffusion layer 1 (e.g., the portion to be at approximately 45° C.) is preferably 50 nm or more and less than 200 nm. A pore diameter of 200 nm or more may be too large to provide suitable moisture retention to the gas diffusion layer 1. On the other hand, a pore diameter of less than 50 nm may be too small to provide suitable drainability to the gas diffusion layer 1, and there is a high possibility that the pore is occluded with water.

Here, a pore diameter of 50 nm or more and less than 200 nm is applicable to both the high-temperature portion and the low-temperature portion. However, in the low-temperature portion, the amount of water attached to the peripheral surface of the pore is large. Hence, by that amount, the cross-sectional area of the pore decreases, and gas permeation is impaired.

Thus, even in the case of setting the pore diameter to 50 nm or more and less than 200 nm, it is preferable that the diameter of the pore in the low-temperature portion be larger than the diameter of the pore in the high-temperature portion, rather than setting the diameter of all the pores to be equal. Here, the diameter of the pore in the low-temperature portion can be determined in view of the decrease of cross-sectional area due to attached water.

In the case of selecting the gas permeability by varying the particle diameter of the material constituting the gas diffusion layer 1, the particle diameter of the material in the high-temperature portion of the gas diffusion layer 1 (e.g., the portion to be at approximately 50° C.) is preferably 0.5 μm or more and less than 2.0 μm. If the particle diameter is 2.0 μm or more, the gap formed between particles may be too large to provide suitable moisture retention to the gas diffusion layer 1. On the other hand, if the particle diameter is less than 0.5 μm, the gap may be too small to provide suitable drainability to the gas diffusion layer 1, and there is a high possibility that the gap is occluded with water.

The particle diameter of the material in the low-temperature portion of the gas diffusion layer 1 (e.g., the portion to be at approximately 45° C.) is preferably 2.0 μm or more and less than 10 μm. If the particle diameter is 10 μm or more, the gap formed between particles may be too large to provide suitable moisture retention to the gas diffusion layer 1. On the other hand, if the particle diameter is less than 2.0 μm, the gap may be too small to provide suitable drainability to the gas diffusion layer 1, and there is a high possibility that the gap is occluded with water.

For convenience of description, the case of dividing the gas diffusion layer 1 into two regions is described herein. However, the invention is not limited thereto, but the gas diffusion layer 1 can be divided into three or more regions. It this case, the pore diameter or particle diameter can be increased stepwise from the high-temperature region to the low-temperature region. Alternatively, the pore diameter or particle diameter can be increased gradually from the high-temperature region to the low-temperature region.

FIGS. 1A and 1B illustrate the case where the high-temperature region and the low-temperature region are formed nearly symmetrically, but the invention is not limited thereto. For example, depending on the use environment and thermal insulation condition, the high-temperature region and the low-temperature region may be biased, or the shape of the region may be distorted. Even in such cases, the pore diameter or particle diameter adapted to the respective temperature regions can be selected to provide suitable drainage and moisture retention.

The thickness of the gas diffusion layer 1 is preferably 25 μm or more and 100 μm or less in view of oxygen permeability.

The material of the gas diffusion layer 1 can illustratively be carbon black such as channel black, furnace black, lamp black, thermal black, and acetylene black (carbon fine particles industrially manufactured under quality control). It is noted that carbon blacks are not limited to the foregoing, but can be suitably changed.

FIG. 6 is a schematic graph for illustrating the function of the gas diffusion layer 1.

The vertical axis represents oxygen permeability, indicating higher permeability to oxygen toward the top. The horizontal axis represents the amount of moisture contained in the gas diffusion layer, indicating a larger amount of moisture (lower temperature) toward the right.

The solid line in the graph represents the case of the gas diffusion layer 1 according to this embodiment. In this case, the particle diameter of carbon black in the low-temperature region (second region 1b) is 5.0 μm, and the particle diameter of carbon black in the high-temperature region (first region la) is 1.0 μm. The thickness of the gas diffusion layer 1 is 50 μm.

The dashed line in the graph represents the case of a gas diffusion layer 102 made of carbon black with a uniform particle diameter. In this case, the particle diameter of the carbon black is 1.0 μm. The thickness of the gas diffusion layer 102 is 50 μm.

As shown in FIG. 6, in the gas diffusion layer 102, the gap formed between particles is occluded with water for a large amount of moisture. Hence, as the amount of moisture increases, the gap is gradually occluded with water in the low-temperature outer peripheral portion. Ultimately, the amount of oxygen permeation is accounted for by the gaps in the high-temperature central portion with a low possibility that the gap is occluded with water.

On the other hand, in the gas diffusion layer 1 according to this embodiment, as the amount of moisture increases, moisture is attached to the gap in the low-temperature outer peripheral portion, and the amount of oxygen permeation gradually decreases. However, even if the amount of moisture increases, the gap is not completely occluded with water. Hence, as compared with the gas diffusion layer 102, the oxygen permeability can be significantly increased.

Next, a fuel cell provided with the gas diffusion layer 1 according to this embodiment is illustrated.

FIG. 7 is a schematic view for illustrating the fuel cell according to the embodiment of the invention.

For convenience of description, a direct methanol fuel cell (DMFC), which uses methanol as a fuel, is taken as an example.

As shown in FIG. 7, the fuel cell 3 has a membrane electrode assembly (MEA) 12 as an electromotive section. The membrane electrode assembly 12 includes a fuel electrode composed of a catalyst layer 6 and a gas diffusion layer 7, an air electrode composed of a catalyst layer 4 and a gas diffusion layer 1 according to this embodiment, and a polymer solid electrolyte membrane 5 held between the catalyst layer 6 of the fuel electrode and the catalyst layer 4 of the air electrode.

The catalyst layer 6 of the fuel electrode only needs to be capable of oxidizing an organic fuel, and can illustratively include fine particles made of a solid solution of platinum with at least one metal selected from the group consisting of iron, nickel, cobalt, tin, ruthenium, and gold.

The catalyst layer 4 of the air electrode can illustratively contain a platinum-group element. For example, it can include an elemental metal such as platinum, ruthenium, rhodium, iridium, osmium, and palladium, and a solid solution containing a platinum-group element. The solid solution containing a platinum-group element can illustratively be a platinum-nickel solid solution. However, the invention is not limited thereto, but the material can be suitably modified.

The catalyst contained in the catalyst layer 6 of the fuel electrode and the catalyst layer 4 of the air electrode can be a supported catalyst using a conductive support such as a carbon material, or can be a non-supported catalyst.

The polymer solid electrolyte membrane 5 can be primarily composed of a material having proton conductivity, and can illustratively be a fluorine-based resin having a sulfonic acid group (e.g., a perfluorosulfonic acid polymer) or a hydrocarbon-based resin having a sulfonic acid group. However, the invention is not limited thereto, but the material can be suitably modified.

Here, the polymer solid electrolyte membrane 5 can be a membrane made of a porous material having through holes or a membrane made of an inorganic material having openings, in which the through holes or openings are filled with a polymer solid electrolyte material, or can be a membrane made of a polymer solid electrolyte material.

The gas diffusion layer 7 provided on the surface of the catalyst layer 6 of the fuel electrode serves to uniformly supply fuel to the catalyst layer 6.

The gas diffusion layer 1 according to this embodiment provided on the surface of the catalyst layer 4 of the air electrode serves to uniformly supply oxygen to the catalyst layer 4, and also serves to adjust the degree of permeation of water produced in the catalyst layer 4 (drainability and moisture retention).

A conductive layer 8 is laminated on the gas diffusion layer 7 of the fuel electrode, and a conductive layer 2 is laminated on the gas diffusion layer 1 of the air electrode. The conductive layer 8 and the conductive layer 2 can be illustratively made of a porous layer such as a mesh of gold or other conductive metal material, or a gold foil having a plurality of openings. The conductive layer 2 and the conductive layer 8 are electrically connected to each other through a load, not shown.

The conductive layer 8 on the fuel electrode side is connected to a liquid fuel tank 10 serving as a fuel supply portion through a gas-liquid separation membrane 9. The gas-liquid separation membrane 9 serves as a vapor-phase fuel permeation membrane, which is only permeable to the vaporized component of liquid fuel and not permeable to the liquid fuel.

The gas-liquid separation membrane 9 is disposed so as to occlude the opening, not shown, provided to extract the vaporized component of liquid fuel in the liquid fuel tank 10. The gas-liquid separation membrane 9 separates the vaporized component of the fuel from the liquid fuel and further vaporizes the liquid fuel, and can be illustratively made of silicone rubber or other material.

Further on the liquid fuel tank 10 side of the gas-liquid separation membrane 9, it is possible to provide a permeation amount adjusting membrane, not shown, having a gas-liquid separation function like the gas-liquid separation membrane 9 and adjusting the permeated amount of the vaporized component of fuel. The permeated amount of the vaporized component through this permeation amount adjusting membrane is adjusted by varying the opening ratio of the permeation amount adjusting membrane. This permeation amount adjusting membrane can be illustratively made of polyethylene terephthalate or other material. Such a permeation amount adjusting membrane allows gas-liquid separation of fuel and adjustment of the amount of the vaporized component of fuel supplied to the catalyst layer 6 of the fuel electrode.

The liquid fuel stored in the liquid fuel tank 10 can be a methanol aqueous solution having a concentration exceeding 50 mole % or pure methanol. In the case of pure methanol, its purity can be 95 weight % or more and 100 weight % or less. The vaporized component of liquid fuel refers to vaporized methanol in the case of using pure methanol as the liquid fuel, and to an air-fuel mixture of the vaporized component of methanol and the vaporized component of water in the case of using a methanol aqueous solution as the liquid fuel.

On the other hand, a cover 11 is laminated to the conductive layer 2 of the air electrode. The cover 11 is provided with a plurality of air inlets, not shown, for taking in air (oxygen) as an oxidizer. The cover 11 also serves to pressurize the membrane electrode assembly 12 to enhance adhesion therein, and hence can be illustratively made of metal such as SUS304.

Next, the function of the fuel cell 3 according to this embodiment is described.

The methanol aqueous solution (liquid fuel) in the liquid fuel tank 10 is vaporized to generate an air-fuel mixture of vaporized methanol and steam, which permeates the gas-liquid separation membrane 9. Then, the air-fuel mixture further passes through the conductive layer 8, is diffused in the gas diffusion layer 7, and is supplied to the catalyst layer 6. The air-fuel mixture supplied to the catalyst layer 6 undergoes the oxidation reaction given by the following formula (1):

CH₃OH+H₂O→CO₂+6H⁺+6e⁻ (1)

In the case of using pure methanol as the liquid fuel, no steam is supplied from the liquid fuel tank 10. Hence, the oxidation reaction of the above formula (1) is caused by the water generated in the catalyst layer 4 of the air electrode, described below, and the water in the polymer solid electrolyte membrane 5 in combination with methanol.

Protons (H⁺) produced by the oxidation reaction of the above formula (1) conduct in the polymer solid electrolyte membrane 5 and reach the catalyst layer 4 of the air electrode. Electrons (e⁻) produced by the oxidation reaction of the above formula (1) are supplied from the conductive layer 8 to a load, not shown, do work therein, and then reach the catalyst layer 4 through the conductive layer 2 and the gas diffusion layer 1.

Air (oxygen) taken in through the air inlets, not shown, of the cover 11 permeates the conductive layer 2, is diffused in the gas diffusion layer 1, and is supplied to the catalyst layer 4. Oxygen in the air supplied to the catalyst layer 4 reacts with protons (H⁺) and electrons (e⁻), which have reached the catalyst layer 4, by the following formula (2) to produce water:

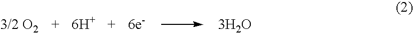

Part of the water generated in the catalyst layer 4 of the air electrode by this reaction permeates the gas diffusion layer 1 to reach vapor-liquid equilibrium inside the gas diffusion layer 1. Vaporized water is evaporated from the air inlets, not shown, of the cover 11. Water in liquid form is stored in the catalyst layer 4 of the air electrode. At this time, part of the water remains in the gas diffusion layer 1. However, the gas diffusion layer 1 according to this embodiment can prevent pores or interparticle gaps from being occluded with water. Hence, oxygen permeability can be enhanced. Furthermore, the moisture retention described above can be ensured.

As the reaction of formula (2) proceeds, the amount of produced water increases, and the amount of moisture stored in the catalyst layer 4 of the air electrode increases. Then, with the progress of the reaction of formula (2), the amount of moisture stored in the catalyst layer 4 of the air electrode becomes larger than the amount of moisture stored in the catalyst layer 6 of the fuel electrode.

Consequently, the water produced in the catalyst layer 4 of the air electrode migrates by osmosis through the polymer solid electrolyte membrane 5 to the catalyst layer 6 of the fuel electrode. Hence, as compared with the case where the supply of moisture to the catalyst layer 6 of the fuel electrode relies only on steam vaporized from the liquid fuel tank 10, the supply of moisture is facilitated, and the reaction of the above formula (1) can be accelerated. Thus, the output density can be increased, and the increased output density can be maintained for a long period of time.

More specifically, even in the case where a methanol aqueous solution having a methanol concentration exceeding 50 mole % or pure methanol is used as a liquid fuel, the water which has migrated from the catalyst layer 4 of the air electrode to the catalyst layer 6 of the fuel electrode can be used for the reaction of the above formula (1). Furthermore, reaction resistance to the reaction of the above formula (1) can be further reduced to improve the long-term output characteristics and load current characteristics. Moreover, the liquid fuel tank 10 can be downsized. Furthermore, high proton (H⁺) conductivity can be achieved because the polymer solid electrolyte membrane 5 can be moistened.

Next, a method for manufacturing the gas diffusion layer 1 according to the embodiment of the invention is illustrated.

FIG. 8 is a flow chart for illustrating the method for manufacturing a gas diffusion layer according to the embodiment of the invention.

First, carbon black is dispersed into a solution of water and alcohol-based solvent to produce a mixed solution of carbon black. Here, a mixed solution dispersed with carbon black having a prescribed particle diameter is produced for each region of the in-plane temperature distribution or each region of the in-plane water distribution in the gas diffusion layer 1 (step S1).

For example, to form the first region 1a, which is to be at high temperature (with a small amount of moisture), carbon black having a particle diameter of 1.0 μm is dispersed into a solution of water and alcohol-based solvent to produce a mixed solution 30a. Likewise, to form the second region 1b, which is to be at low temperature (with a large amount of moisture), carbon black having a particle diameter of 5.0 μm is dispersed into a solution of water and alcohol-based solvent to produce a mixed solution 30b.

Next, the mixed solution is applied to the surface of the catalyst layer 4 of the air electrode and dried to form a gas diffusion layer 1. Here, a prescribed mixed solution is applied and dried for each region of the in-plane temperature distribution or each region of the in-plane water distribution (step S2).

For example, the mixed solution 30a containing carbon black having a small particle diameter and the mixed solution 30b containing carbon black having a large particle diameter are applied, respectively, to the first region 1a, which is to be at high temperature (with a small amount of moisture), and the second region 1b, which is to be at low temperature (with a large amount of moisture), to a prescribed thickness (e.g., approximately 50 μm), and dried. The applying step and the drying step can be repeated a plurality of times.

Next, a method for manufacturing the fuel cell 3 according to this embodiment is illustrated.

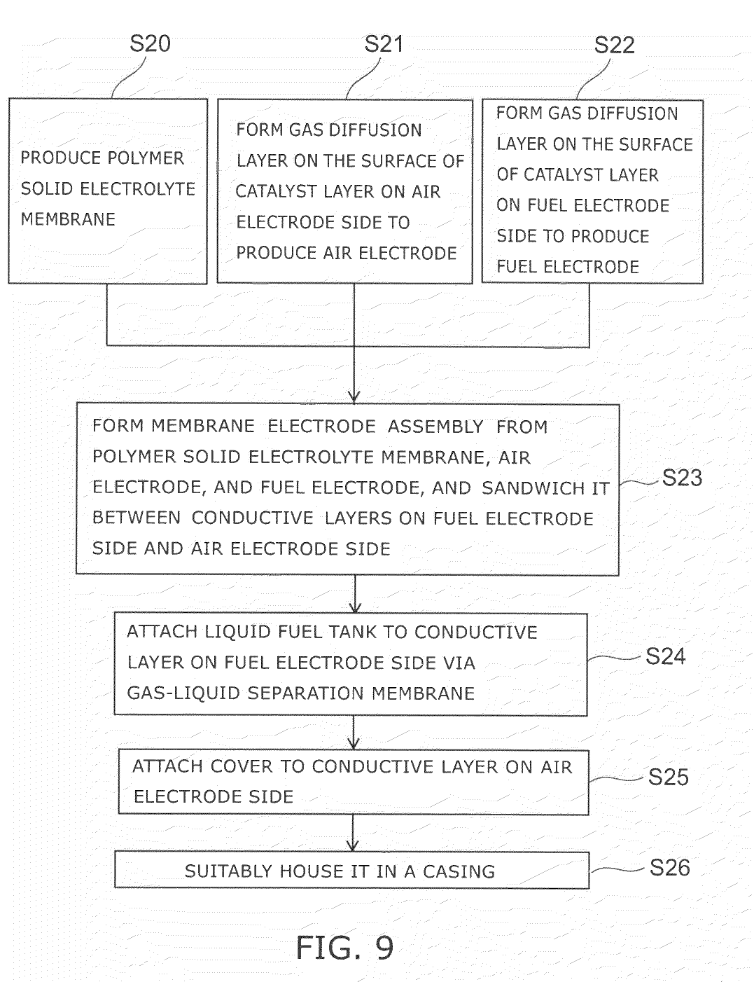

FIG. 9 is a flow chart for illustrating the method for manufacturing a fuel cell according to the embodiment of the invention.

First, a porous material membrane is produced using chemical or physical methods such as the phase separation method, the foaming method, and the sol-gel method. The porous material membrane can be suitably based on commercially available porous materials. For example, a polyimide porous membrane having a thickness of 25 μm and an opening ratio of 45% (UPILEX-PT™, manufactured by Ube Industries, Ltd.) can be used.

A polymer solid electrolyte is filled in this porous material membrane to produce a polymer solid electrolyte membrane 5 (step S20). The method for filling the polymer solid electrolyte can illustratively include immersing the porous material membrane in an electrolyte solution, and pulling it up and drying it to remove the solvent. The electrolyte solution can illustratively be Nafion® (manufactured by DuPont) solution. It is noted that the polymer solid electrolyte membrane 5 can be a membrane made of a polymer electrolyte material. In this case, there is no need to produce a porous material membrane and fill a polymer solid electrolyte therein.

Next, platinum fine particles, particulate or fibrous carbon such as activated charcoal or graphite, and a solvent are mixed into paste form and dried at room temperature to produce a catalyst layer 4 of the air electrode. Then, using the above-described method for manufacturing the gas diffusion layer 1, a gas diffusion layer 1 is formed on the surface of the catalyst layer 4 to produce an air electrode (step S21).

On the other hand, fine particles illustratively made of a platinum-nickel solid solution, particulate or fibrous carbon such as activated charcoal or graphite, and a solvent are mixed into paste form and dried at room temperature to produce a catalyst layer 6 of the fuel electrode. A gas diffusion layer 7 is formed on the surface of the catalyst layer 6 to produce a fuel electrode (step S22). The gas diffusion layer 7 can be formed by, for example, dispersing carbon black having a particle diameter of 1.0 μm into a solution of water and alcohol-based solvent to produce a mixed solution, and applying it to the surface of the catalyst layer 6 and drying it.

Next, a membrane electrode assembly 12 is formed from the polymer solid electrolyte membrane 5, the air electrode (catalyst layer 4 and gas diffusion layer 1), and the fuel electrode (catalyst layer 6 and gas diffusion layer 7), and sandwiched between a conductive layer 8 and a conductive layer 2, which are illustratively made of gold foil having a plurality of openings for taking in vaporized methanol or air (step S23).

Next, a liquid fuel tank 10 is attached to the conductive layer 8 via a gas-liquid separation membrane 9 (step S24). The gas-liquid separation membrane 9 can be illustratively made of a silicone sheet.

Next, a cover 11 is attached to the conductive layer 2 (step S25). The cover 11 can be illustratively made of a stainless steel plate (SUS304), which has air inlets, not shown, for taking in air.

Finally, this is suitably housed in a casing to form a fuel cell 3 (step S26).

The embodiment of the invention has been illustrated. However, the invention is not limited to the above description.

The above embodiment can be suitably modified by those skilled in the art, and such modifications are also encompassed within the scope of the invention as long as they fall within the spirit of the invention.

For example, the shape, dimension, material, and layout of each element of the gas diffusion layer 1 and the fuel cell 3 described above are not limited to those illustrated, but can be suitably modified.

With regard to the fuel, a methanol aqueous solution is taken as an example. However, the fuel is not limited thereto. Besides methanol, other fuels can include alcohols such as ethanol and propanol, ethers such as dimethyl ether, cycloparaffins such as cyclohexane, and cycloparaffins having a hydrophilic group such as a hydroxy group, carboxy group, amino group, and amido group. Such fuel is typically used as an aqueous solution with approximately 5 to 90 weight %.

The elements included in the above embodiment can be combined as long as feasible, and such combinations are also encompassed within the scope of the invention as long as they fall within the spirit of the invention.

1. A gas diffusion layer to be provided on an air electrode of a fuel cell, the gas diffusion layer comprising:
a portion to be at a relatively high temperature; and
a portion to be at a relatively low temperature,
gas permeability of the portion to be at a relatively high temperature being different from gas permeability of the portion to be at a relatively low temperature.

2. The gas diffusion layer according to claim 1, wherein the diameter of a pore provided in the gas diffusion layer or the dimension of a particle constituting the gas diffusion layer is larger in the portion to be at a relatively low temperature.

3. The gas diffusion layer according to claim 2, wherein the diameter of the pore or the dimension of the particle increases stepwise from the portion to be at a relatively high temperature to the portion to be at a relatively low temperature.

4. The gas diffusion layer according to claim 2, wherein the diameter of the pore or the dimension of the particle increases gradually from the portion to be at a relatively high temperature to the portion to be at a relatively low temperature.

5. The gas diffusion layer according to claim 1, wherein the diameter of a pore provided in the gas diffusion layer is 50 nm or more and less than 200 nm.

6. The gas diffusion layer according to claim 1, wherein the diameter of a pore provided in the portion to be at a relatively high temperature is 5 nm or more and less than 200 nm.

7. The gas diffusion layer according to claim 1, wherein the diameter of a pore provided in the portion to be at a relatively low temperature is 50 nm or more and less than 200 nm.

8. The gas diffusion layer according to claim 1, wherein the dimension of a particle provided in the portion to be at a relatively high temperature is 0.5 μm or more and less than 2.0 μm.

9. The gas diffusion layer according to claim 1, wherein the dimension of a particle provided in the portion to be at a relatively low temperature is 2.0 μm or more and less than 10 μm.

10. The gas diffusion layer according to claim 1, wherein the gas diffusion layer has a thickness dimension of 25 μm and 100 μm or less.

11. The gas diffusion layer according to claim 1, wherein the gas diffusion layer includes carbon fine particles industrially manufactured under quality control.

12. The gas diffusion layer according to claim 1, wherein the gas diffusion layer includes at least one selected from the group consisting of channel black, furnace black, lamp black, thermal black, and acetylene black.

13. A gas diffusion layer to be provided on an air electrode of a fuel cell, the gas diffusion layer comprising:
a portion to contain a relatively large amount of water; and
a portion to contain a relatively small amount of water, gas permeability of the portion to contain a relatively large amount of water being different from gas permeability of the portion to contain a relatively small amount of water.

14. The gas diffusion layer according to claim 13, wherein the diameter of a pore provided in the gas diffusion layer or the dimension of a particle constituting the gas diffusion layer is larger in the portion to contain a relatively large amount of water.

15. The gas diffusion layer according to claim 14, wherein the diameter of the pore or the dimension of the particle increases stepwise from the portion to contain a relatively small amount of water to the portion to contain a relatively large amount of water.

16. The gas diffusion layer according to claim 14, wherein the diameter of the pore or the dimension of the particle increases gradually from the portion to contain a relatively small amount of water to the portion to contain a relatively large amount of water.

17. A fuel cell comprising:
a fuel electrode to be supplied with a fuel;
an air electrode to be supplied with an oxidizer; and
a polymer solid electrolyte membrane sandwiched between the fuel electrode and the air electrode, the air electrode having a gas diffusion layer to be provided on an air electrode of a fuel cell, the gas diffusion layer including:
a portion to be at a relatively high temperature; and
a portion to be at a relatively low temperature, gas permeability of the portion to be at a relatively high temperature being different from gas permeability of the portion to be at a relatively low temperature.

18. A method for manufacturing a gas diffusion layer to be provided on an air electrode of a fuel cell, the gas diffusion layer including a first portion to be at a relatively high temperature and a second portion to be at a relatively low temperature during operation of the fuel cell, the method comprising:
applying mixed solutions dispersed with carbon black having different particle diameters to the first portion and the second portion; and
drying the mixed solutions.

19. A method for manufacturing a gas diffusion layer to be provided on an air electrode of a fuel cell, the gas diffusion layer including a first portion to contain a relatively large amount of water and a second portion to contain a relatively small amount of water during operation of the fuel cell, the method comprising:
applying mixed solutions dispersed with carbon black having different particle diameters to the first portion and the second portion; and
drying the mixed solutions.

20. A method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method comprising:
manufacturing a gas diffusion layer to be provided on the air electrode by a method for manufacturing a gas diffusion layer to be provided on an air electrode of a fuel cell, the gas diffusion layer including a first portion to be at a relatively high temperature and a second portion to be at a relatively low temperature during operation of the fuel cell, the method including:
applying mixed solutions dispersed with carbon black having different particle diameters to the first portion and the second portion; and
drying the mixed solutions.
